(19) United States
(12) Patent Application Publication
(10) Pub. No.: US 2009/0029029 A1
(43) Pub. Date: Jan. 29, 2009

(54) APPARATUS AND METHOD FOR MANUFACTURING A CONSUMABLE CANDY DRINKING STRAW

(76) Inventor: Benjamin LIN, Yung-He (TW)

Correspondence Address: BERENATO, WHITE & STAVISH, LLC, 6550 ROCK SPRING DRIVE, SUITE 240, BETHESDA, MD, 20817, US

(21) Appl. No.: 12/172,477

(22) Filed: Jul. 14, 2008

Related U.S. Application Data
(60) Provisional application No. 60/949,548, filed on Jul. 13, 2007.

(51) Int. Cl. A23G 3/50; B29D 23/00; B29C 33/44; B29C 41/32; B29C 41/38

(52) U.S. Cl. 426/660; 264/214; 264/299; 264/312; 425/436 R

(57) ABSTRACT

An apparatus and method for manufacturing a candy drinking straws includes a system for arranging a soft mass of sugar composition around a solid mold having a support cord extending from an end thereof, rolling the sugar composition along a surface of the solid mold using a plurality of rotating scrolls rotating around the solid mold to shape the sugar composition into a hollow tube, the sugar composition being pushed along the solid mold onto the support cord, pulling the sugar composition along the support cord to form hollow cylindrical candy, and cutting the hollow cylindrical candy into a plurality of hollow candy segments.

### CROSS-REFERENCE TO RELATED APPLICATIONS AND CLAIMS TO PRIORITY

The present application claims priority from U.S. Provisional Patent Application No. 60/949,548 filed Jul. 13, 2007, the contents of which are incorporated herein by reference and to which priority is claimed.

### BACKGROUND OF THE INVENTION

1. Field of the Invention

The present invention relates to an apparatus and method for manufacturing a consumable candy drinking straw.

2. Background of the Invention

Candy is typically a single function and single use product. A consumer generally buys a candy product for the sole purpose of consuming the candy. There are various forms of candy, including hard candy, typically manufactured primarily from sugar and flavoring, chocolate, soft candy, etc. Hard candy having a chocolate or flavored center is known. Regardless of its type, the candy typically is consumed by itself when the candy is placed in the mouth of a consumer.

Fruit flavored beverages, sometimes called “smoothies,” have recently become popular. A typical smoothie has finely ground ice particles combined with flavoring. Frequently, finely ground fruit is the flavoring in a smoothie. Due to its thick consistency, the smoothie typically is consumed with a straw or sometimes a straw that also functions as a spoon. The spoon or straw usually is made from plastic and allows the consumer to suck the smoothie from the cup or receptacle holding it.

Because the straw is formed of plastic, it imparts no flavor to the smoothie and merely allows the smoothie to be withdrawn from the receptacle. There thus exists a need for a mechanism to alter and/or augment the smoothie's flavor.

In addition, there is a need for a candy product that can be used for purposes other than simply consumption. There is also a need for creative and fun candy products that have some utility other than their flavor.

### SUMMARY OF THE INVENTION

The present invention provides a method of manufacturing a candy drinking straw. The method includes arranging a soft mass of sugar composition around a solid mold having a support cord extending from an end thereof, rolling the sugar composition along a surface of the solid mold using a plurality of rotating scrolls rotating around the solid mold to shape the sugar composition into a hollow tube, the sugar composition being pushed along the solid mold onto the support cord, pulling the sugar composition along the support cord to form hollow cylindrical candy, and cutting the hollow cylindrical candy into a plurality of hollow candy segments.

The soft mass of sugar composition may be produced from liquefied sugar and glucose syrup. Before arranging the soft mass of sugar composition on the solid mold, a plurality of soft masses of sugar compositions of different colors and different flavors may be combined into a single mass of sugar composition.

After pulling the sugar composition along the support cord to form hollow cylindrical candy, the hollow cylindrical candy may be twisted with respect to the support cord to form swirled candy stripes on the candy. The twisting of the hollow cylindrical candy may be performed by transferring the hollow cylindrical candy on the support cord between a plurality of rotating belt units arranged opposite to one another each rotating in different directions to apply different forces to the candy such that the candy is twisted with respect to the support cord.

The hollow cylindrical candy may be removed from an end of the support cord before cutting the candy.

The support cord may have a diameter that corresponds to an inner diameter of the candy drinking straw. For example, the diameter of the support cord may be about 5 millimeters.

The solid mold may have a conical shape with the support cord extending from a smaller bore of the solid conical mold. Additionally, the support cord may be bound inside the solid mold at a first end thereof and extends inside along a length of the solid mold out of a second end thereof.

The pulling of the sugar composition along the support cord may be performed by moving the sugar composition along a movement track defined by a plurality of rollers that apply a rotational pressure to move and pull the sugar composition along the support cord. In addition, the sugar composition may be pulled along the support cord to form a hollow cylindrical candy having an outer diameter of about 12 millimeters and a thickness of about 3.5 millimeters.

The present invention also provides a candy drinking straw manufacturing apparatus to manufacture a candy drinking straw. The manufacturing apparatus includes a scrolling unit to receive a solid mold having a soft mass of sugar composition arranged therearound. The scrolling unit includes a plurality of scrolls rotating around the solid mold to shape the sugar composition into a hollow tube and to push the sugar composition along the solid mold onto a support cord extending from an end of the solid mold. The apparatus further includes a pulling unit to pull the sugar composition along the support cord to form hollow cylindrical candy and a cutting unit to cut the hollow cylindrical candy into a plurality of hollow candy segments.

The soft mass of sugar composition may be made from liquefied sugar and glucose syrup. The soft mass of sugar composition may include a plurality of soft masses of sugar compositions of different colors and different flavors.

The manufacturing apparatus may further include a twisting unit to receive the hollow cylindrical candy from the pulling unit and to twist the hollow cylindrical candy with respect to the support cord to form swirled candy stripes on the candy. The twisting unit includes a plurality of rotating belt units arranged opposite to one another each rotating in different directions to apply different forces to the hollow cylindrical candy to twist the candy with respect to the support cord when the candy is transferred between the rotating belt units.

An end of the support cord may be arranged between the pulling unit and the cutting unit such that the hollow cylindrical candy is removed from the support cord prior to cutting. The support cord may have a diameter that corresponds to an inner diameter of the candy drinking straw, for example, about 5 millimeters.

The solid mold may have a conical shape with the support cord extending from a small bore of the solid conical mold. The support cord may be bound inside the solid mold at a first end thereof and extends inside along a length of the solid mold out of a second end thereof.

The pulling unit may include a plurality of rollers arranged in two parallel lines defining a movement track therebetween. The rollers apply a rotational pressure to move and pull the sugar composition along the support cord disposed in the movement track. The pulling unit may pull the sugar composition along the support cord to form a hollow cylindrical candy having an outer diameter of about 12 millimeters and a thickness of about 3.5 millimeters.

The present invention also provides another candy drinking straw manufacturing apparatus to manufacture a candy drinking straw. The manufacturing apparatus includes a scrolling unit having a rotating support member around which a soft candy mass is arranged. The rotating support member has a first end disposed in the scrolling unit and a second end extending out of the scrolling unit and is rotated and pressed by the scrolling unit to gradually decrease a diameter of the soft candy mass from the first end toward the second end of the rotating support member. The apparatus further includes a pulling unit to pull the sugar composition along the rotating support member to form hollow cylindrical candy, and a cutting unit to cut the hollow cylindrical candy into a plurality of hollow candy segments. The rotating support member may include a conical portion disposed in the scrolling unit and a cylindrical portion extending from the conical portion out of the scrolling unit into the pulling unit.

The present invention further provides a candy scrolling apparatus. The candy scrolling apparatus includes a housing, a plurality of scrolls disposed in the housing along a length thereof, the scrolls being rotatable with respect to the housing and defining a recess extending along the length of the housing, a conical mold disposed in the recess and extending along the length of the housing to be rotated by rotational forces received from the scrolls, and a support cord extending from a smaller end of the conical mold out of the housing.

The candy scrolling apparatus further includes a soft sugar composition mass arranged around the conical mold being rotated and molded by the scrolls such that the soft sugar composition mass is transferred along a surface of the conical mold to a surface of the support cord by forces applied by the rotating scrolls. The soft sugar composition mass may be formed into a hollow cylindrical shape around the support cord when the scrolls are rotated.

The support cord may be made of plastic.

The present invention further provides a candy mold usable to form a candy drinking straw. The candy mold includes an elongated conical portion having a small end and a large end, and an elongated cylindrical portion extending from the small end of the conical portion. The candy mold is insertable in a scrolling machine having a plurality of rotating scrolls to gradually roll a candy mass around the conical portion onto the cylindrical portion to shape the candy mass into a tubular candy cylinder.

### BRIEF DESCRIPTION OF THE DRAWINGS

FIG. 1 illustrates a side elevational view of a candy drinking straw.

FIG. 2 is a cross-sectional view of the candy drinking straw of FIG. 1.

FIG. 3 illustrates a method of manufacturing a candy drinking straw according to an embodiment of the present invention.

FIG. 4 illustrates a continuation of the method of FIG. 3.

FIG. 5 illustrates a method of manufacturing a candy drinking straw according to another embodiment of the present invention.

FIG. 6 illustrates a solid mold usable in the methods of FIGS. 3 to 5.

FIG. 7 illustrates the solid mold of FIG. 6 with a support cord usable in the methods of FIGS. 3 to 5.

FIG. 8 illustrates the solid mold of FIGS. 6 and 7 having the support cord extending therethrough.

FIG. 9 is a top view of a plurality of scrolls in a scroll machine usable in the methods of FIGS. 3 to 5.

FIG. 10 is a perspective view of the scroll machine of FIG. 9.

FIG. 11 illustrates a sugar composition mass rolled along the solid mold onto the support cord of FIGS. 7, 8, and 10.

FIG. 12 is a top view of a pulling device usable in the methods of FIGS. 3 to 5.

FIG. 13A is a top view of a twisting device usable in the methods of FIGS. 3 to 5.

FIG. 13B is a side view of a rotating belt unit of the twisting device of FIG. 13A.

FIG. 14A is a front view of a cutting device usable in the methods of FIGS. 3 to 5.

FIG. 14B is a side view of the cutting device of FIG. 14A.

FIG. 15 is a top view of an exemplary straw removal device usable in the methods of FIGS. 3 to 5.

FIG. 16 is a block diagram of a candy straw manufacturing apparatus according to another embodiment of the present invention.

### DESCRIPTION OF THE EMBODIMENTS OF THE INVENTION

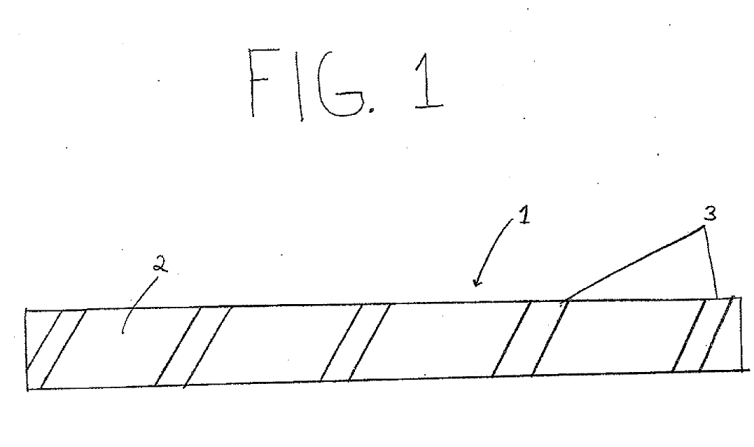

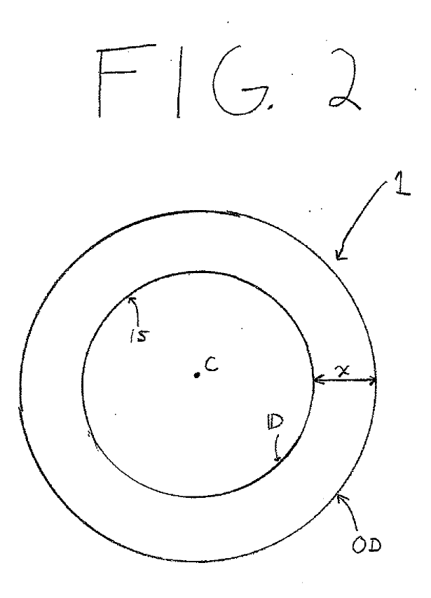

FIG. 1 illustrates a candy drinking straw 1 according to an embodiment of the present invention, and FIG. 2 illustrates a cross-sectional view of the candy drinking straw 1 of FIG. 1. As best shown in FIG. 2, the candy drinking straw 1 has a hollow cylindrical interior structure 15 and can be used to drink beverages from a container, for example, milkshakes, smoothies, cold coffee drinks, ice cream floats, and other beverages. The candy drinking straw 1 is made of glassified sugar candy, and is sufficiently rigid to be inserted into a relatively thick beverage and to be able to transport heavy beverages from the receptacle to the mouth of the user. The glassified sugar may be made by heating a sugar solution to a temperature of 300 degrees Fahrenheit, forming the drinking straw while the sugar solution is still hot/warm, and then allowing the sugar solution cool.

The candy drinking straw 1 can enhance the flavor of whatever beverage is being enjoyed by a consumer. The candy drinking straw 1 maintains a stable solid state and is only relatively slowly dissolved from within by the beverage being transported therein and by the saliva from the mouth of the user. On the other hand, a consumer's saliva may dissolve an outer portion of the candy drinking straw 1 to add flavor to the beverage being consumed. Once the consumer finishes the beverage, the candy drinking straw 1 may be consumed or may be re-used with another beverage.

Referring to FIG. 1, the candy drinking straw 1 has a candy shell with a main candy portion 2 and a secondary candy portion 3 that is twisted with the main candy portion 2. The main candy portion 2 and the secondary candy portion 3 may be different candy flavors, different candy colors, etc.

The arrangement of the main candy portion 2 and the secondary candy portion 3 of the candy drinking straw 1 provides an aesthetically appealing drinking straw design while providing the consumer with the choice of different flavors of the main and twisted candy portions 2 and 3. Structurally, the twisted candy portion 3 may reinforce the main candy portion 2 of the candy drinking straw 1 to make the candy drinking straw 1 more difficult to crack or break during transport, insertion, or use.

It should be understood that although the candy drinking straw 1 is described as having the twisted candy portion 3, more than one twisted candy portion or no twisted candy portion may be used in alternative embodiments of the invention. For example, the candy drinking straw 1 may be a single color/flavor solid candy shell. In another example, the candy drinking straw 1 may have several twisted candy portions 3, each providing a different color candy and/or a different candy flavor in addition to the main candy portion 2.

Although the twisted candy portion 3 shown in FIG. 1 and described herein is diagonally arranged around the candy drinking straw with respect to a lengthwise axis of the candy drinking straw 1, it should also be understood that the twisted candy portion 3 may alternatively be arranged parallel to the lengthwise axis of the candy drinking straw 1 (i.e., lengthwise stripes) or perpendicular with respect to the lengthwise axis of the candy drinking straw 1 (i.e., circumferential stripes). Other variations of the main and twisted candy portions 2 and 3 may also be used with the present invention. The candy drinking straw 1 may be made different lengths to accommodate different beverages.

Referring now to FIG. 2, the candy drinking straw 1 has a hollow cylindrical interior 15 and includes a thickness (x), a lengthwise center axis (c), an inner diameter of the candy drinking straw (ID), and an outer diameter of candy drinking straw (OD). The thickness (x) of the candy drinking straw 1 is such that the candy drinking straw does not collapse during beverage consumption. For example, even when a consumer is drinking a thick beverage, e.g., a smoothie, requiring the consumer to apply a relatively large suction to an end of the candy drinking straw 1 in order to move the beverage up to the user's mouth, the dimensions and rigidity of the candy drinking straw 1 are such that the candy drinking straw 1 remains intact and stable. Hence, the candy drinking straw 1 will not collapse when suction is applied.

In an exemplary embodiment of the invention, the outer diameter (OD) of the candy drinking straw 1 may be approximately 10 to 14 millimeters (mm), the inner diameter (ID) may be approximately 4 to 6 mm, and the thickness (x) of the candy drinking straw 1 may be approximately 3 to 4 mm. More particularly, the candy drinking straw 1 may be made such that the outer diameter (OD) is about 12 mm, the thickness (x) of the candy drinking straw 1 is about 3.5 mm, and the inner diameter (ID) of the candy drinking straw 1 is about 5 mm.

By comparison, most conventional plastic drinking straws have an inner diameter of about 7.5 mm. Other dimensions may also be used with embodiments of the present invention as long as the thickness (x) of the candy drinking straw 1 of the candy drinking straw 1 is large enough to withstand suction applied by the consumer in order to transport thick/heavy beverages without breakage. Additionally, the inner diameter (ID) of the candy drinking straw 1 may be large enough such that a thick milk shake, cookie crumbs, pieces of fruit, etc. may be transported therethrough by the suction applied by the consumer.

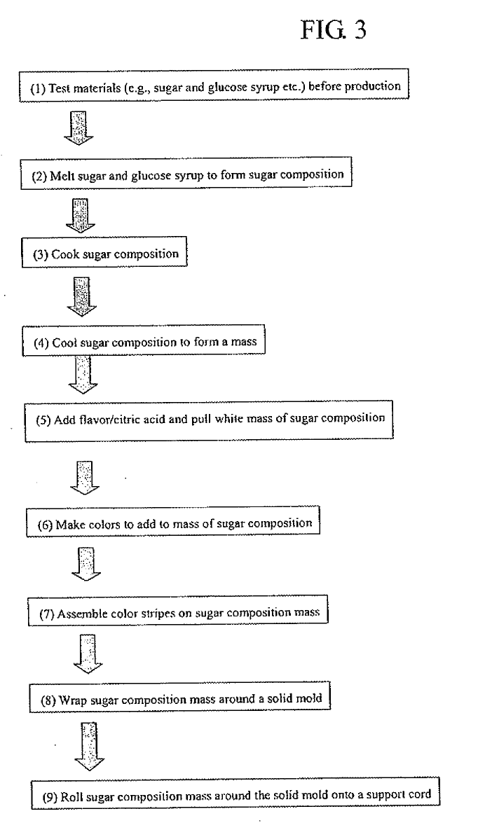

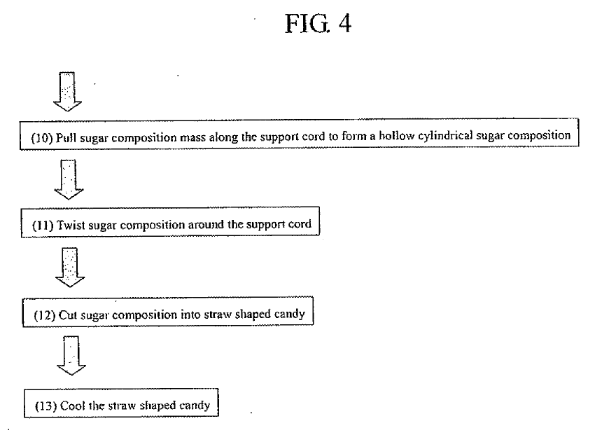

FIGS. 3 and 4 illustrate a method of manufacturing the candy drinking straw 1 according to an embodiment of the present invention. Referring to FIG. 3, at step 1, materials to be used to manufacture the candy drinking straw (e.g., sugar, glucose syrup, etc.) are tested before beginning production. Obviously, in some cases, the materials need not be tested, and step 1 may be omitted from the method illustrated in FIGS. 3 and 4.

At step 2, the sugar is melted and combined with liquid glucose syrup to produce a sugar composition that may be made into solid candy when it is cooled. The sugar composition may then be combined with water in a ratio of about 1:1 in order to adjust the consistency of the mixture. At step 3, the sugar composition is heated. For example, the liquefied sugar may be heated in a vacuum cooking machine. During this step, the water is driven off, and the sugar composition becomes a soft relatively solid mass when the temperature of the vacuum cooking reaches around 150 degrees Celsius.

The sugar composition is then cooled at step 4. During this step, the sugar composition is removed from the vacuum cooking machine to be shaped, molded, processed, etc. into drinking straws. After the sugar composition is cooked, it has a consistency similar to that of dough or support clay. As the sugar composition cools, it can be shaped. For example, in step 4, the sugar composition may be placed on a cooling table and formed into a “brick.” Cooling devices known in the art may also be use in step 4.

At step 5, flavor and citric acid are added to the soft mass of sugar composition. Here, the mass of sugar composition is “pulled” to add air to the mass of sugar composition. The pulling may be performed by hand using a hook mounted on a wall or a table. Alternatively, the pulling can be performed by a machine. A dose of food grade colors of about 0.2% to 0.4% by weight of the sugar composition is then added. This step 5 may be performed while the sugar composition remains in the heat preserving condition.

Colors to be added to the sugar composition are then made at step 6. At step 7, color stripes are assembled about the sugar composition. A dose of the colors may be about 0.1% to 0.5% by weight of the cooked sugar composition. For example, red color and yellow color may be added to the sugar composition using government health department certified food colors. In this step, several soft masses of different color candy stripes may be positioned next to each other. Here, stripes of colored candy are mounted on the outside of the brick (i.e., the mass of sugar composition), which will eventually form the outside colors of the candy drinking straw 1.

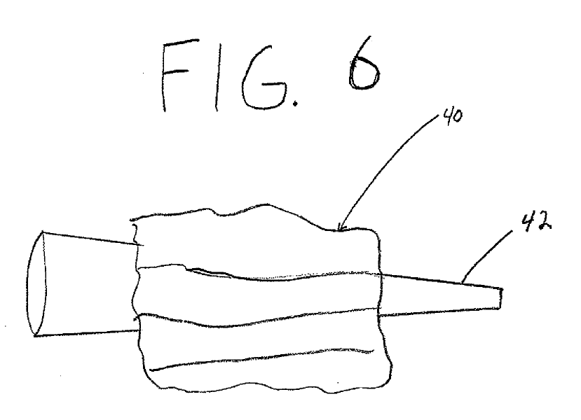

A solid mold is then positioned inside the soft mass of sugar composition at step 8 for processing by the scroll machine. FIG. 6 illustrates a solid mold 42 having an outer surface around which a soft sugar composition mass 40 is positioned. The solid mold 42 may have a hollow or tubular structure. The sugar composition 40 may include various different color/flavor soft candy masses. Alternatively, a single color sugar composition mass 40 may surround solid mold 42.

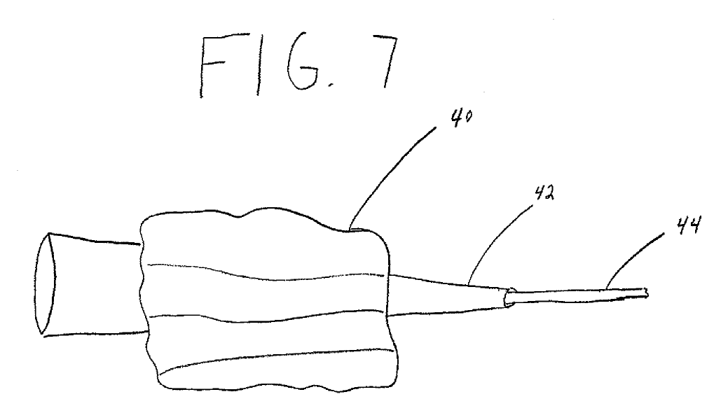

FIG. 7 illustrates the solid mold 42 of FIG. 6 with a support cord 44 disposed therein and extending from a bore formed in the mold 42. The support cord 44 may be tied or bound inside the solid mold 42 and extend from the scroll machine (described below). The support cord 44 extends from the solid mold 42 with a sufficient length such that other subsequent process steps (and/or processing components), which are described below, can be performed on the sugar composition mass 40 while the sugar composition mass 40 remains on the support cord 44. The support cord 44 may be made from plastic or other materials. Additionally, the support cord 44 may be made from a flexible and/or a resilient material.

The solid mold 42 may have a conical shape. In this case, the conical shape enables the sugar composition 40 to be gradually pushed around the surface of the solid mold 42 onto the support cord 44 with ease by the scroll machine (described below).

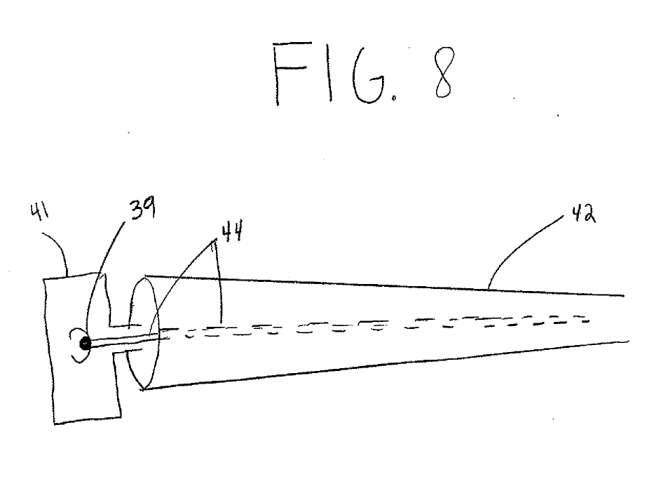

FIG. 8 illustrates the solid mold 42 of FIGS. 6 and 7 having the support cord 44. As can be seen in FIG. 8, the larger end of the solid mold 42 has an engagement part 41 extending therefrom to engage the scroll machine (described below). The engagement part 41 has a coupling part 39 to which the support cord 44 is bound. The support cord 44 may be tied or attached to the coupling part 39. The support cord 44 extends from the coupling part 39 through the solid mold 42 to the smaller end of the solid mold 42. That is, the support cord 44 extends from a first end inside of the solid mold 42 out through the second end of the solid mold 42. The solid mold 42 may have a hollow or tubular structure.

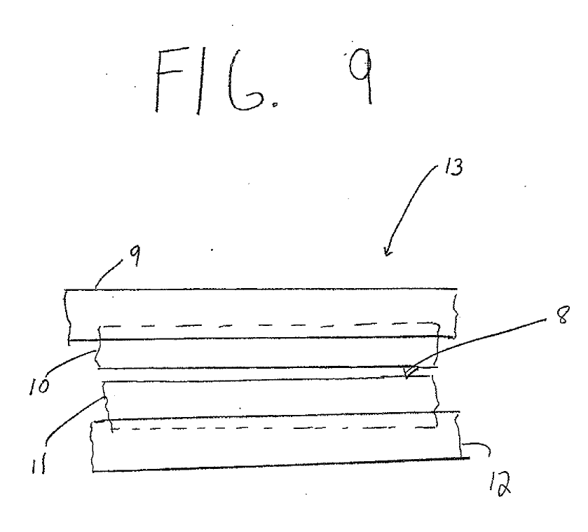

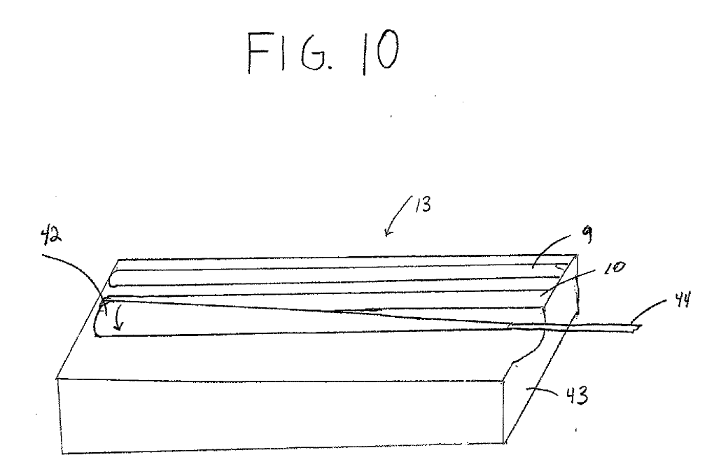

FIG. 9 illustrates a top view of a plurality of rotatably driven scrolls 9, 10, 11, and 12 of a scroll machine 13. FIG. 10 is a perspective view of the scroll machine 13 of FIG. 9. The scroll machine 13 stretches the sugar composition mass 40 along the solid mold 42 onto the support cord 44.

Referring to FIGS. 9 and 10, the scrolls 9, 10, 11, and 12 are arranged in a housing 43 and define a center recess portion 8 in which the solid mold 42 having the soft mass of sugar composition 40 is placed. The engagement part 41 (see FIG. 8) of the solid mold 42 may engage a corresponding portion of the housing 43 to fix the solid mold 42 in a predetermined position for processing.

The scrolls 9, 10, 11, and 12 rotate to roll and mold the sugar composition mass 40 (see FIGS. 6 and 7) into a hollow shape around the solid mold 42 in order to form a long hollow tube of candy. Additionally, the scrolls 9, 10, 11, and 12 in the scroll machine 13 apply pressure to roll the sugar composition 40 along the surface of the solid mold 42 onto the support cord 44, as best shown in FIGS. 7, 8, and 10. Because the sugar composition mass 40 may include various soft candy masses of different colors and flavors that are still warm and soft from being heated, the various soft candy masses agglutinate on the solid mold 42 to become one soft mass of sugar composition 40. The scroll machine 13 is powered by a power source (not shown).

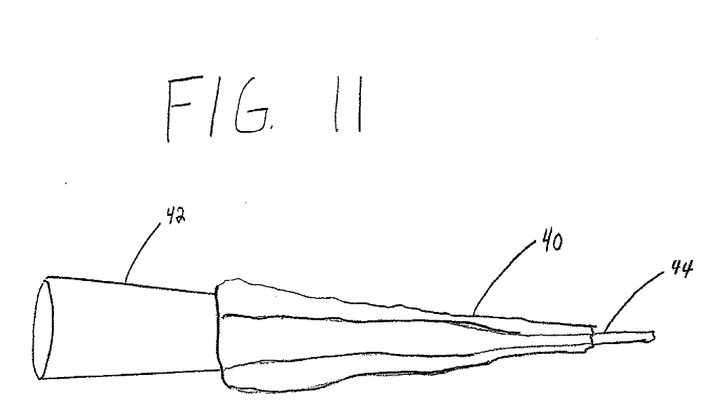

FIG. 11 illustrates a sugar composition mass 40 rolled along the solid mold 42 onto the support cord 44 of FIGS. 7, 8, and 10. As can be seen in FIG. 11, the scroll machine 13 of FIGS. 9 and 10 has stretched the sugar composition 40 along the surface of the solid mold 42 onto the support cord 44. The conical shape of the solid mold 42 has a diameter that gradually decreases toward the support cord 44. The sugar composition mass 40 is rolled by the scroll machine 13 (see FIGS. 9 and 10) such that an outer diameter of the sugar composition mass 40 also gradually decreases from the larger end of the solid mold 42 toward the smaller end of the solid mold 42 and onto the support cord 44. The support cord 44 may have a diameter of about 5 millimeters to form an inner diameter of the candy drinking straw 1.

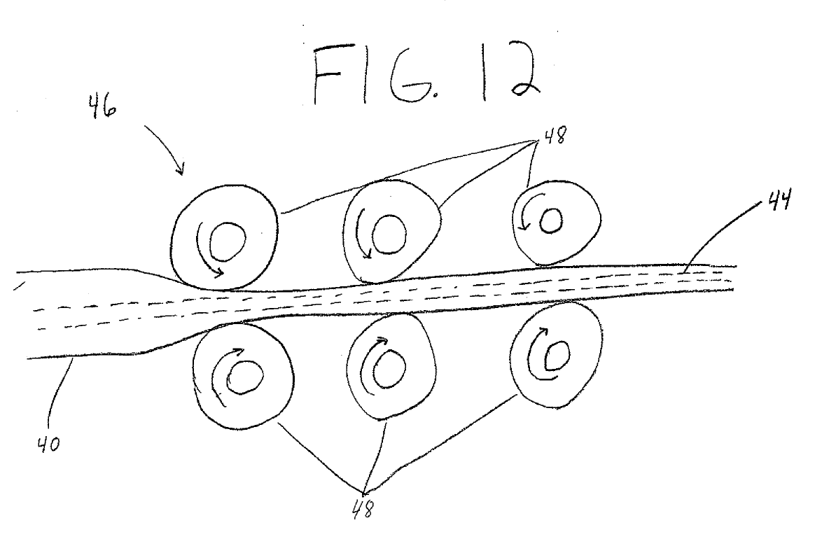

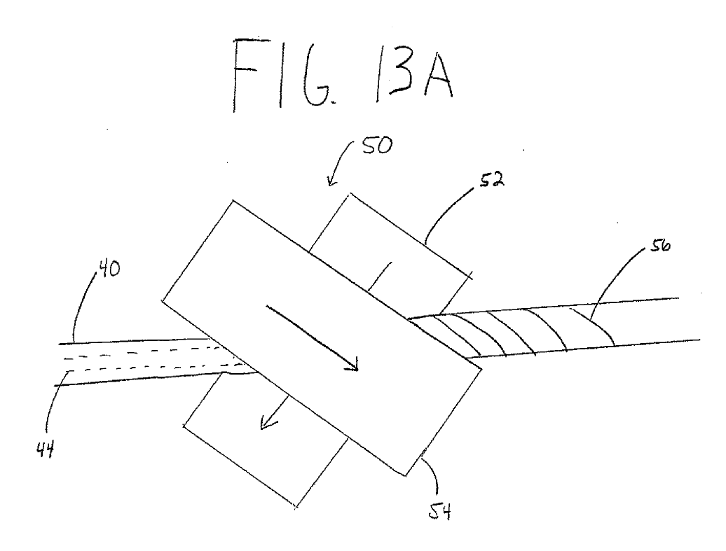

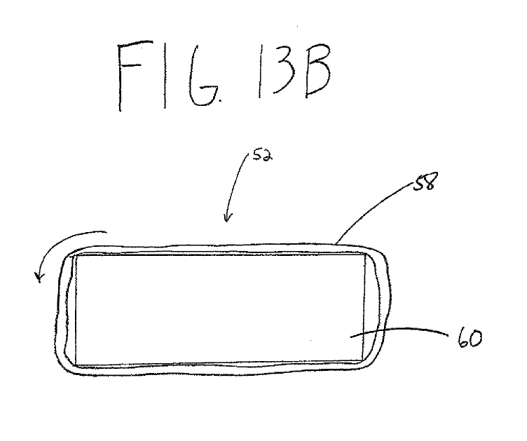

Although the solid mold 42 and the support cord 44 are shown and described as being distinct components coupled to each other at the coupling part 39 (see FIG. 8), it should be understood that the solid mold 42 and the support cord 44 may be formed as one integral component. For example, a rotating support member having a conical portion, which corresponds to the scroll machine 13 (see FIGS. 9 and 10), and a cylindrical portion, which extends from the scroll machine 13 (see FIGS. 9 and 10) to a pulling device 46 (see FIG. 12) and twisting device 50 (see FIGS. 13A and 13B), may be used as an alternative to the solid mold 42 and the support cord 44. The rotating support member may be made of plastic.

Referring to FIG. 4, at step 10, the cylindrically molded sugar composition is processed by a pulling machine. FIG. 12 is a top view of a pulling device 46 (i.e., the pulling machine) usable in the methods of FIGS. 3 to 5. Specifically, the pulling device 46 includes a plurality of rollers 48 arranged to form a movement track along which the sugar composition 40 is pulled along the support cord 44 (represented by the dashed line in FIG. 12) by rolling and stretching to make the hollow tube of candy (i.e., the sugar composition 40) thinner and longer. The rollers 48 may be arranged in pairs on opposite sides of the movement track such that rollers 48 on opposite sides of the movement track rotate in opposite directions. The rollers 48 are rotated by a power source (not shown).

The sugar composition mass 40 is then twisted by a twisting machine. FIG. 13A is a top view of a twisting device 50 (i.e., the twisting machine) usable in the methods of FIGS. 3 to 5. FIG. 13B is a side view of a rotating belt unit 52 of the twisting device 50 of FIG. 13A. As best can be seen in FIG. 13A, the twisting device 50 includes an opposing pair of rotating belt units 52 and 54 along which the sugar composition 40, which is disposed around the support cord 44 represented by a dashed line, is transferred. As illustrated in FIG. 13B, the rotating belt unit 52 includes a belt 58 and a rotating base 60 that provides a rotational force to the belt 58. The rotating belt unit 54 may have a similar configuration to the rotating belt unit 52 shown in FIG. 13B. Referring back to FIG. 13A, the rotating belt units 52 and 54 include a first rotating belt unit 52 and a second rotating belt unit 54 arranged opposite each other along different directions. The first rotating belt unit 52 may be arranged vertically below the second rotating belt unit 54 such that a transfer path is formed therebetween. The first and second rotating belt units 52 and 54 may be arranged to rotate in perpendicular directions with respect to each other such that, as the sugar composition 40 on the support cord 44 is transferred along the transfer path between the first and second rotating belt units 52 and 54, the rotating belt units 52 and 54 exert forces that are diagonal with respect to a longitudinal axis of the support cord 44 to twist the sugar composition 40 around the support cord 44. As a result, any colors in the sugar composition 40 are twirled. The twisting device 50 diagonally winds candy stripes 56 of different color candy to give the finished candy drinking straw an aesthetically appealing candy swirl appearance. This process can be referred to as “twining” the soft mass of sugar composition 40. This step may be performed when the sugar composition mass 40 includes candy of more than one color/flavor. The support cord 44 extends along the transfer path to an output end of the twisting device 50.

A cutting machine cuts the twisted cylindrical sugar composition mass 40. The end of the support cord 44 may be disposed between the twisting device 50 and the cutting machine. Specifically, before being cut by the cutting machine, the twisted cylindrical sugar composition 40 is pushed off the end of the support cord 44 by pressure from other sugar composition mass 40 (i.e., “upstream” sugar composition mass 40) being pushed by the scroll machine 13 (see FIGS. 9 and 10), the pulling device 46 (see FIG. 12), and the twisting device 50 (see FIGS. 13A and 13B). The continuous supply of sugar composition mass 40 provided by the scroll machine 13 maintains the steady flow of the cylindrical sugar composition mass 40 moving “downstream” in the system. Once the twisted cylindrical sugar composition mass 40 is separated from the support cord 44, the twisted cylindrical sugar composition mass 40 is cut in segments by a cutting machine.

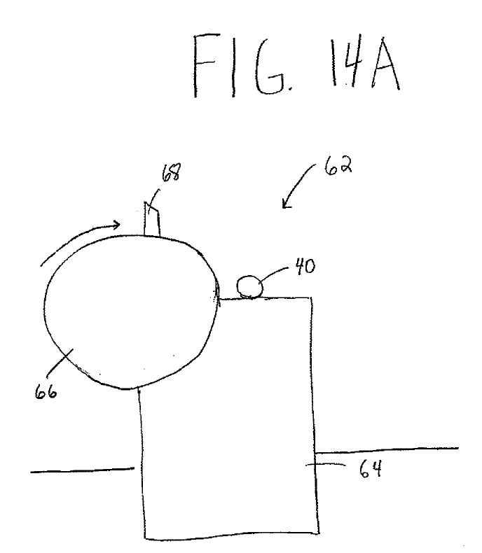

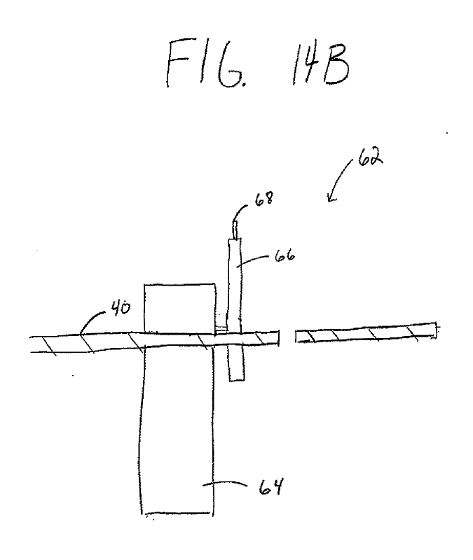

FIG. 14A is a front view of a cutting device 62 (i.e., the cutting machine) usable with the invention. FIG. 14B is a side view of the cutting device 62 of FIG. 14A. As can be seen in FIGS. 14A and 14B, the cutting device 62 includes a base 64, a rotator 66 supported by the base 62, and a blade 68 disposed on the rotator 66 to cut the sugar composition 40 when rotated. The base 64 also supports the sugar composition 40. A power source (not shown) applies power to the base 64 to rotate the rotator 66. Although not shown in FIGS. 14A and 14B, the base 64 may include an alignment part to guide the sugar composition 40 to a proper position to be cut by the blade 68 upon rotation of the rotator 66. As illustrated in FIG. 14B, the sugar composition 40 has the shape of the candy drinking straw 1 (see FIGS. 1 and 2) after being cut by the blade 68.

In another embodiment of the invention, the support cord 44 may extend beyond the cuffing machine such that the sugar composition 40 is cut on the support cord 44. In this case, the sugar composition 40 may be removed from the support cord 44 after the cutting device 62 cuts the sugar composition 40. In this embodiment, the cutting device 62 cuts the sugar composition 40 around the support cord 44 without cutting the support cord 44. The support cord 44 with the cut candy segments (i.e., the sugar composition 40) can then be shaken such that the pieces of the cut sugar composition (candy) 40 fall from the support cord 44, one by one. Alternatively, the cut candy segments can be removed manually from the support cord 44. Other methods of removing the cut candy segments from the support cord 44 may alternatively be used with the present invention.

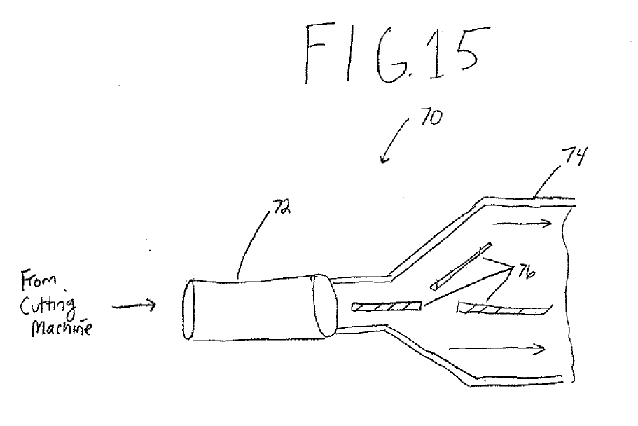

Referring back to FIG. 4, the pieces of the sugar composition mass 40, which are now shaped as candy drinking straws, are then moved along a cooling conveyor in order to be completely solidified. Other cooling devices and/or cooling methods may alternatively be used with the present invention. FIG. 15 is a top view of an exemplary straw removal device 70 usable in the methods of FIGS. 3 to 5. The straw removal device 70 includes a tube 72 to receive the cut candy segments from the cutting device 62. In this case, the cut candy segments are collected from the tube 72 on an output platform 74 as the candy drinking straws 1 (see FIGS. 1 and 2). The output platform 74 may be a moving conveyer along which the candy drinking straws 1 (see FIGS. 1 and 2) are cooled. At this point, the candy drinking straws are complete and ready for packaging and/or shipping.

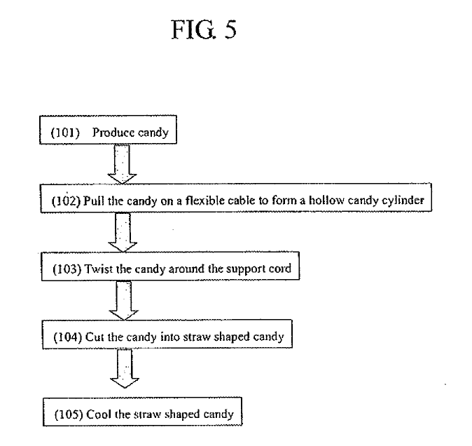

FIG. 5 illustrates a method of manufacturing the candy drinking straw 1 (see FIGS. 1 and 2) according to another embodiment of the invention. The method of FIG. 5 includes step 101 in which candy is produced, step 102 in which the candy is pulled on a scroll machine to make a hollow tube of candy on a support cord, step 103 in which the candy is twisted to give the hollow candy tube a swirl or twining, step 104 in which the hollow candy tube is cut into segments, and step 105 in which the segments of the hollow candy tube are cooled and finalized into candy drinking straws 1 (see FIGS. 1 and 2).

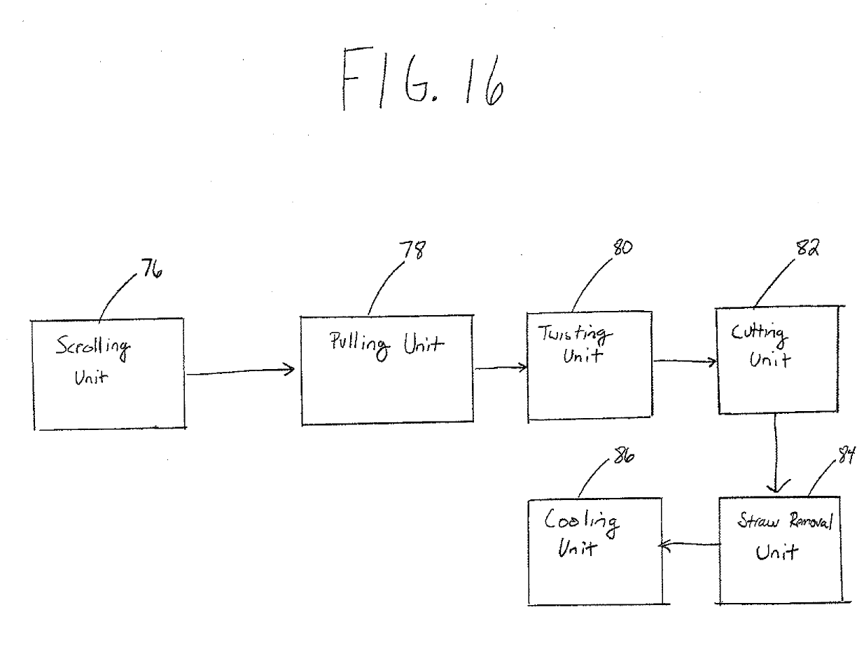

FIG. 16 is a block diagram of a candy straw manufacturing system according to another embodiment of the present invention. The candy straw manufacturing system includes a scrolling unit 76, a pulling unit 78, a twisting unit 80, a cutting unit 82, a straw removal unit 84, and a cooling unit 86. The scrolling unit 76 rolls a mass of sugar composition (e.g., a “brick” of candy) wrapped around a solid mold (not shown) onto a straw support cord (e.g., the support cord 44 shown in FIGS. 7, 8, 10, 11, 12, and 13A). The pulling unit 78 pulls the rolled sugar composition along the straw support cord (not shown). The twisting unit 80 then twists the pulled sugar composition around the straw support cord such that any colors are twirled diagonally around the straw support cord. Here, the twisted sugar composition may be removed from the straw support cord. The cutting unit 82 cuts the sugar composition, and the straw removal unit 84 removes candy drinking straws 1 (see FIGS. 1 and 2) from the cutting unit 82. The cooling unit 86 cools the candy drinking straws 1 (see FIGS. 1 and 2) upon removal by the straw removal unit 84.

In some embodiments of the present invention, the removed candy drinking straws 1 can be cooled to room temperature without applying a cooling device. In these embodiments, the cooling unit 86 may be omitted from the candy drinking straw manufacturing apparatus. Additionally, in some embodiments of the present invention in which the candy drinking straws 1 (see FIGS. 1 and 2) do not have a twirled color appearance, the twisting unit 80 may also be omitted. Furthermore, in some embodiments of the present invention, the straw removal unit 84 may be integrated with the cooling unit 86 as an output unit of the candy drinking straw manufacturing apparatus.

Although embodiments of the present invention have been shown and described, it will be appreciated by those skilled in the art that changes may be made in these embodiments without departing from the principles and spirit of the invention, the scope of which is defined in the appended claims and their equivalents.

What I claim is:

1. A method of manufacturing a candy drinking straw, comprising the steps of:
arranging a soft mass of sugar composition around a solid mold having a support cord extending from an end thereof,
rolling the sugar composition to shape the sugar composition into a hollow tube;
moving the sugar composition along the support cord to form hollow cylindrical candy; and
cutting the hollow cylindrical candy into a plurality of hollow candy segments.

2. The method of claim 1, further comprising the step of:
producing the soft mass of sugar composition from liquefied sugar and glucose syrup.

3. The method of claim 1, further comprising the step of:
providing as the soft mass a plurality of soft masses of sugar compositions of different colors and different flavors.

4. The method of claim 1, wherein the soft mass of sugar composition comprises a plurality of different colors of candy, and the method further comprises the step of:
after moving the sugar composition along the support cord, twisting the hollow cylindrical candy with respect to the support cord to form swirled candy stripes about the candy.

5. The method of claim 4, wherein the step of twisting the hollow cylindrical is performed by twisting the candy with a plurality of rotating belts.

6. The method of claim 1, further comprising the step of:
removing the hollow cylindrical candy from an end of the support cord before cutting the candy.

7. The method of claim 1, including the step of providing a support cord that has a diameter that corresponds to an inner diameter of the candy drinking straw.

8. The method of claim 7, including the step of providing a support cord having a diameter of about 5 millimeters.

9. The method of claim 1, including the step of providing a solid mold that has a conical shape with the support cord extending from a bore of the solid conical mold.

10. The method of claim 1, including the step of moving the sugar composition along a movement track defined by a plurality of rollers that apply a rotational pressure to move and pull the sugar composition along the support cord.

11. The method of claim 1, including the step of providing a support cord to form a hollow cylindrical candy having an outer diameter of about 12 millimeters and a thickness of about 3.5 millimeters.

12. The method of claim 1, including the step of providing a support cord that is bound inside the solid mold at a first end thereof and extends out of a second end thereof.

13. A system to manufacture a candy drinking straw, the system comprising:
a scrolling unit to receive a solid mold having a soft mass of sugar composition arranged therearound, the scrolling unit having a plurality of rotating scrolls rotatable about the solid mold to shape the sugar composition into a hollow tube and to move the sugar composition along the solid mold onto a support cord extending from an end of the solid mold;
a movement unit cooperating with said scrolling unit and operable to move the sugar composition along the support cord to form hollow cylindrical candy; and
a cutting unit cooperating with said movement unit and operable to cut the hollow cylindrical candy into a plurality of hollow candy segments.

14. The system of claim 13, further comprising:
a twisting unit cooperating with said movement unit and operable to twist the hollow cylindrical candy with respect to the support cord to form swirled candy stripes on the candy.

15. The system of claim 14, wherein said twisting unit comprises a plurality of rotatable belt units arranged opposite to one and operable to apply forces to the hollow cylindrical candy to twist the candy with respect to the support cord.

16. The system of claim 13, wherein an end of the support cord is arranged between the movement unit and the cutting unit for removing the candy from the support cord prior to cutting.

17. The system of claim 13, wherein the support cord has a diameter of about 5 millimeters.

18. The system of claim 13, wherein the solid mold has a conical shape.

19. The system of claim 13, wherein said movement unit comprises a plurality of rollers cooperating to define a movement track therebetween, the rollers applying a rotational pressure to move and pull the sugar composition along the support cord disposed in the movement track.

20. The apparatus of claim 13, wherein the movement unit moves the sugar composition along the support cord to form a hollow cylindrical candy having an outer diameter of about 12 millimeters and a thickness of about 3.5 millimeters.

21. The apparatus of claim 13, wherein the support cord is bound inside the solid mold at a first end thereof and extends out of a second end thereof.

22. A candy drinking straw manufacturing apparatus to manufacture a candy drinking straw, the apparatus comprising:
a scrolling unit having a rotating support member around which a soft candy mass is arranged, the rotating support member having a first end disposed in the scrolling unit and a second end extending out of the scrolling unit for being rotated and pressed by said scrolling unit to gradually decrease a diameter of the soft candy mass from the first end toward the second end of the rotating support member;
a pulling unit operably associated with said scrolling unit for pulling the sugar composition along said rotating support member to form hollow cylindrical candy; and
a cutting unit operably associated with said pulling unit for cutting the hollow cylindrical candy into a plurality of hollow candy segments.

23. The apparatus of claim 25, wherein said rotating support member comprises a conical portion disposed in said scrolling unit and a cylindrical portion extending said conical portion into said pulling unit.

24. A candy scrolling apparatus, comprising:
a housing;
a plurality of scrolls disposed in the housing along a length thereof, said scrolls being rotatable with respect to said housing and defining a recess extending along the length of said housing;
a conical mold disposed in said recess and extending along the length of said housing to be rotated by rotational forces received from the scrolls; and
a support cord extending from said conical mold out of said housing.
